(19) United States
(12) Patent Application Publication
(10) Pub. No.: US 2023/0241963 A1
(43) Pub. Date: Aug. 3, 2023

(54) METHOD AND SYSTEM FOR FUEL TANK CAP DETECTION

(71) Applicant: PLASTIC OMNIUM ADVANCED INNOVATION AND RESEARCH, Bruxelles (BE)

(72) Inventors: David HILL, Bruxelles (BE); Antoine CHAUSSINAND, Bruxelles (BE); Mihai BAJA, Bruxelles (BE); Jonathan KELLER, Bruxelles (BE)

(73) Assignee: PLASTIC OMNIUM ADVANCED INNOVATION AND RESEARCH, Bruxelles (BE)

(21) Appl. No.: 18/002,763

(22) PCT Filed: Jun. 24, 2021
(86) PCT No.: PCT/EP2021/067365

§ 371 Date: Dec. 21, 2022

(30) Foreign Application Priority Data
Jun. 26, 2020 (EP) 20182570.0

(51) Int. Cl. B60K 15/035; B60S 5/02

(52) U.S. Cl. CPC B60K 15/03519; B60S 5/02; B60K 2015/03566

(57) ABSTRACT

A method may verify that a fuel tank cap is present and properly closed after refueling of a motor vehicle fuel tank. The method may include, in response to a request for refueling: (a1) enabling refueling of the motor vehicle fuel tank by opening a first vent valve connected in series in a vent line, downstream from a first port of a recirculation line coupled to the vent line, so that to vent the motor vehicle fuel tank to the atmosphere through a fuel vapor canister; (b1) disabling refueling of the motor vehicle fuel tank by closing the first vent valve; (c1) monitoring the internal pressure within the motor vehicle fuel tank when the refueling request is finished; and (d1) concluding that the fuel tank cap is deemed present and properly closed when the internal pressure increases and/or remains higher than the atmospheric pressure.

### TECHNICAL FIELD OF THE INVENTION

The present invention relates to a method for verifying that a fuel tank cap is present and properly closed after refueling of a motor vehicle fuel tank.

The present invention also relates to a recirculation line for a fuel tank assembly, a fuel tank assembly for a motor vehicle comprising the recirculation line, a fuel tank cap detection system comprising the fuel tank assembly, a motor vehicle comprising the fuel tank cap detection.

### BACKGROUND OF THE INVENTION

A fuel tank generally contains fuel in gaseous and liquid form. In particular conditions, like temperature increase for instance, a dangerous build-up of pressure may occur inside the fuel tank. For that reason it is advantageous to vent the fuel tank through a vent line, providing there is no emission of fuel vapors to the atmosphere.

In order to prevent this emission, the fuel tank is generally vented using an evaporative emission control (EVAP) system comprising, in general, a fuel vapor canister containing an adsorptive material (e.g. charcoal filter) through which fuel vapors escaping from the fuel tank are directed.

Regulatory requirements mandate the implementation of an on-board diagnostic (OBD) leak detection system to determine whether there is a leak in the EVAP system of the vehicle. The OBD leak detection system must trigger a malfunction indicator light (MIL) when a leak of sufficient size is detected. A sufficient size is typically an orifice larger than 0.5 mm in diameter for vehicles produced starting model year 2000. Should a fuel tank cap not be replaced or improperly closed after a refueling event, the OBD leak detection system would detect the missing or loose cap as a leak in the EVAP system and trigger the MIL. Such a common oversight as failure to replace the fuel tank cap, however, is not in actuality a leak in the EVAP system intended to be monitored by the system and essentially amounts to a false leak indication. Because an excessive number of EVAP repairs may trigger a recall for a given maker of automobile, it is desirable to distinguish operator error from actual leaks. As such, the regulatory agencies in question allow the separate detection and indication of a missing or loose fuel tank cap in order to prevent unneeded service to the EVAP system.

Current technologies involving leak detection are separated into detection of very small, small and large leaks. Small leak detection method relates to the detection of a leak equivalent to an opening having a diameter smaller than 1 mm, and large leaks detection method relates to the detection of a leak equivalent to an opening having a diameter greater or equal to 12 mm and corresponding to a fuel tank cap off condition (i.e. the filler pipe is not closed on the fill side). The detection method of very small leaks corresponds to the detection of a leak equivalent to an opening with a diameter of about 0.5 mm.

Prior inventions for detecting leaks use concepts of pressure levels and/or vacuum levels in the fuel tank. Some of them also use purge concepts to do the measurements.

An example of leak detection method using pressure levels is revealed in patent application US2009314072A1, in the applicant's name, which discloses a leak detection method using natural pressure build up inside the fuel tank. The leak detection method of this patent application consists in at least partially sealing the fuel tank from the atmosphere, measuring the system pressure while the fuel tank is sealed off and if the pressure reaches a desired threshold, sending a “passing” status to a control system. The problem with this leak detection method is that it requires the engine to start again after having been switched off.

While this last method works for gasoline-powered vehicles, it is not suited for hybrid electric vehicles. Indeed, it is not the internal combustion engine of a hybrid electric vehicle that is supposed to start after a refueling event but the electric motor in order to enable fuel economy and reduced carbon emissions benefits. Furthermore, this leak detection method does not take advantages of fuel vapor recirculation since it does not comprise a vapor recirculation line. Vapor recirculation lines serve to both limit the rate of fuel vapor canister loading during refueling and to provide a path to the filler head for evaporative emissions testing.

In view of the above, there exists a need for an improved fuel tank cap detection method that overcomes disadvantages of the prior art.

### SUMMARY OF THE INVENTION

The present invention provides a method for verifying that a fuel tank cap is present and properly closed after refueling of a motor vehicle fuel tank, the method comprises in response to a request for refueling the steps of:

a1) enabling refueling of the motor vehicle fuel tank by opening a first vent valve connected in series in a vent line, downstream from a first port of a recirculation line coupled to the vent line, so that to vent the motor vehicle fuel tank to the atmosphere through a fuel vapor canister,
b1) disabling refueling of the motor vehicle fuel tank by closing the first vent valve,
c1) monitoring the internal pressure within the motor vehicle fuel tank when the refueling request is finished,
d1) concluding that the fuel tank cap is deemed present and properly closed when the internal pressure increases and/or remains higher than the atmospheric pressure.

A request for refueling is typically an activation of a button or a flap inside the vehicle to open the fuel door. Venting the motor vehicle fuel tank to the atmosphere allows decreasing the internal pressure of the motor vehicle fuel tank to a predetermined pressure level in preparation for refueling. The internal pressure is the pressure generated by the fuel vapors. The terms “upstream” and “downstream” are defined relative to the normal flow direction of the fuel vapor in the vent line. Closing the first vent valve allows to ramp pressure in the fuel tank to cause an automatic shutoff of a refueling dispenser during refueling. The refueling request is finished when one of the following events occurs: the fuel door is closed, the ignition key is turned on with the engine off (i.e. not running) or a preset time period is reached. In an example, the preset time period is about 5 minutes. In an example, the internal pressure is at least 300 Pa (3 mbar) above atmospheric pressure. In an example, the internal pressure values are provided by a pressure sensor coupled to the fuel tank. In an example, the pressure sensor is a relative pressure sensor.

At the end of a refueling event, there are typically two phenomenon: a rapid drop in tank pressure due to fuel vapor exiting the filler head via the recirculation line and, upon properly closing the fuel tank cap, a pressure rise in the fuel tank. The pressure rise in the fuel tank is due to the turbulence of the fuel in the tank and the unbalanced equilibrium of high vapor pressure molecules in the air-vapor mixture. Therefore, at the end of a refueling request, if the internal pressure does not increase and/or does not remain higher than the atmospheric pressure, it is an indication that the fuel tank cap is loose or missing.

Advantageously, the fuel tank cap detection method according to the present invention does not require the internal combustion engine to start for verifying that the fuel tank cap is present and properly closed after a refueling event, therefore it is suitable for both gasoline-powered vehicles and hybrid electric vehicles. Furthermore, the fuel tank cap detection method according to the invention takes advantages of fuel vapor recirculation.

According to a first sub-embodiment of the invention, the method proceeds to step b1) when the refueling request is finished. This allows the fuel tank cap detection method to be executed regardless of the amount of fuel present in the fuel tank.

According to a second sub-embodiment of the invention, the method proceeds to step b1) when the fuel volume has reached a target fuel volume. This allows the fuel tank cap detection method to be executed when the fuel volume has reached a target fuel volume. In an example, the target fuel volume is the maximum rated capacity of the fuel tank. In this example, the fuel level in the fuel tank is provided by a fuel level sensor coupled to the fuel tank.

Preferably, the second sub-embodiment of the invention further comprises after step b1), the steps of:

a2) enabling refueling of the motor vehicle fuel tank by sequentially opening and closing the first vent valve,
b2) incrementing a counter value by one,
c2) determining whether the counter value has reached a threshold value, if the counter value has reached the threshold value, then the method proceeds to step c1); otherwise, the method proceeds to step d2),
d2) determining whether additional fuel has been introduced into the motor vehicle fuel tank, if additional fuel has been introduced into the motor vehicle fuel tank, then the method returns to step a2); otherwise, the method proceeds to step c1).

After the first shutoff, the first valve is re-opened momentarily to vent a precise amount of fuel vapors from the fuel tank, reclosed, and a counter value is incremented by one. These steps repeat until the counter value reaches a threshold value for example of three shutoffs which is, on average, the amount of additional refueling attempts an operator considers to make before being done refueling the vehicle. In an example, the sequential opening and closing of the first vent valve lasts less than one second, preferably, it lasts about 200 ms.

The above mentioned steps a2) to d2) allow the fuel tank cap detection method to be executed when the fuel volume has reached both a target fuel volume and a predetermined number of shutoffs.

According to a third sub-embodiment of the invention, the method further comprises at step a1), the step of opening a second vent valve connected in series in the vent line, upstream from the first port of the recirculation line coupled to the vent line. This allows enabling refueling of the motor vehicle fuel tank when a second vent valve is present in the vent line by opening both the first and the second vent valves, so that to vent the motor vehicle fuel tank to the atmosphere through the fuel vapor canister.

Preferably, the third sub-embodiment of the invention further comprises after step a1), the steps of:

a3) determining whether the volume of fuel contained within the motor vehicle fuel tank has reached a target fuel volume,
b3) disabling refueling of the motor vehicle fuel tank by closing the second vent valve when the fuel volume has reached the target fuel volume,
c3) opening the second vent valve and proceeding to step b1).

The above mentioned steps a3) to c3) allow to ramp pressure in the fuel tank by closing the second vent valve and not the first vent valve.

According to a fourth sub-embodiment of the invention, the method proceeds to step c3) when the refueling request is finished.

One key advantage of keeping the second vent valve closed after the refilling until the refueling request is finished, it is that sufficient pressure can be retained in the fuel tank regardless of the time between the end of refilling and the end of the refueling request. This allows for a very reliable fuel tank cap detection.

Preferably, the third, respectively fourth, sub-embodiment of the invention further comprises after step b3), the steps of:

a4) enabling refueling of the motor vehicle fuel tank by sequentially opening and closing the second vent valve,
b4) incrementing a counter value by one,
c4) determining whether the counter value has reached a threshold value, if the counter value has reached the threshold value, then the method proceeds to step c3); otherwise the method proceeds to step d4),
d4) determining whether additional fuel has been introduced into the motor vehicle fuel tank, if additional fuel has been introduced into the motor vehicle fuel tank, then the method returns to step a4), otherwise, the method proceeds to step c3).

After the first shutoff, the second valve is re-opened momentarily to vent a precise amount of fuel vapors from the fuel tank, reclosed, and a counter value is incremented by one. These steps repeat until the counter value reaches a threshold value for example of three shutoffs which is, on average, the amount of additional refueling attempts an operator considers to make before being done refueling the vehicle. In an example, the sequential opening and closing of the second vent valve lasts less than one second, preferably, it lasts about 200 ms. The above mentioned steps a4) to d4) allow the fuel tank cap detection method to be executed when the second vent valve is used for disabling refueling of the fuel tank and the fuel volume has reached both a target fuel volume and a predetermined number of shutoffs.

According to a fifth embodiment of the invention, if the method does not conclude that the fuel tank cap is deemed present and properly closed, then the method further comprises the steps of:

a5) running an internal combustion engine of a motor vehicle,
b5) applying a purge vacuum to the canister via an engine intake manifold coupled to the engine to verify whether the fuel tank cap is loose or missing.

If the internal pressure does not increase and/or does not remain higher that the atmospheric pressure whilst the refueling request is finished, then the fuel tank cap detection method according to the invention may warn the operator that the fuel tank cap is loose or missing. An operator warning is typically a light on an instrument cluster of the vehicle that illuminates to notify that the fuel tank cap is loose or missing.

Alternatively or in combination with the operator warning, the fuel tank cap detection method may perform an additional step to confirm the large leak by running the internal combustion engine and performing a purge vacuum leak detection. However, it is the belief of the applicant that this action will be extremely rare, thus minimizing the effect on the vehicle fuel consumption and associated carbon emissions.

According to a preferred embodiment of the invention, the first vent valve is a system isolation valve (SIV). A SIV, also called a canister vent valve (CVV), is an electrically actuated valve coupling the canister to the atmosphere and it may be controlled by an electronic control unit (ECU) of the motor vehicle, which is programmed with computer-readable instructions to carry out the fuel tank cap detection method. The SIV allows isolating the fuel tank assembly.

According to a preferred embodiment of the invention, the second vent valve is a tank isolation valve (TIV). A TIV, also called a fuel tank isolation valve (FTIV), is an electrically actuated valve between the fuel tank and the canister to limit the amount of fuel vapors adsorbed by the canister. The TIV according to the invention may close or open the recirculation line at the request of an electronic control unit (ECU) of the motor vehicle, which is programmed with computer-readable instructions to carry out the fuel tank cap detection method.

An object of the present invention concerns also a recirculation line for a fuel tank assembly for a motor vehicle, comprising a first port at one end and a second port at the other end, the first port of the recirculation line being configured to be coupled to a vent line of a fuel tank assembly between an electrically actuated tank isolation valve (TIV) and a fuel vapor canister and the second port of the recirculation line being configured to be coupled to a filler pipe (8) of the fuel tank assembly.

In a conventional fuel tank assembly (see FIG. 3), the recirculation line is typically kept open during a filling operation with the intention to recirculate some fuel vapors back into the liquid fuel stream thus condensing it and avoid it going to the canister. For this purpose, the diameter of the recirculation line can be sufficiently large, i.e. in a range of 3-5 mm. The recirculation line is generally arranged between an opening located on the top of fuel tank and the filler pipe. This arrangement can be disadvantageous for several reasons. First, there is a possibility that liquid fuel can enter into the recirculation line and pool in the line. This liquid fuel can create a hydrostatic pressure differential between the fuel tank and the filler pipe, making it difficult to detect a leak in the filler pipe when the pressure is measured in the filler pipe. To circumvent these disadvantages, a conventional solution is to add a float valve that closes when exposed to liquid to avoid liquid fuel entering the recirculation line. The recirculation line according to the present invention is protected by the electrically actuated tank isolation valve, thus eliminating the risk of liquid fuel entering the recirculation line, all without the need for an additional roll valve in the system.

Additionally it is advantageous to have the recirculation line closed at the end of a refueling event because when the recirculation line is arranged on the fuel tank with a means to close it at the end of a refueling event, for example, by a float valve that rises and closes, the communication between the fuel tank and the filler pipe is lost when the fuel level in the fuel tank is at the highest allowable level (i.e. the maximum rated capacity of the fuel tank). This results in the inability to infer anything about the leak tightness of the filler pipe and recirculation line via the tank pressure sensor until the fuel level in the fuel tank drops to a point which the float valve re-opens. The result is an inability to assess the one element of the fuel tank assembly that has been manipulated manually during the refueling event, with the highest possibility to have a leak introduced.

It is another object of the present invention to provide a fuel tank assembly for a motor vehicle comprising:
the recirculation line,
a motor vehicle fuel tank fillable with fuel through a filler pipe,
a vent line having a first port at one end and a second port at the other end, the first port of the vent line being coupled to the motor vehicle fuel tank and the second port of the vent line communicating with the atmosphere,
a fuel vapor canister connected in series in the vent line and coupled between the first and second ports of the vent line,
an electrically actuated tank isolation valve (TIV) connected in series in the vent line and coupled between the motor vehicle fuel tank and the fuel vapor canister, wherein the first port of the recirculation line is coupled to the vent line between the electrically actuated tank isolation valve (TIV) and the fuel vapor canister and the second port of the recirculation line is coupled to the filler pipe.

A fuel tank assembly for a motor vehicle comprising a recirculation line according to the present invention allows to more precisely control refueling performance in a fuel tank by creating two conditions in terms of recirculation communication. At the end of a refueling event, it is advantageous to have the recirculation line either highly restricted or closed to avoid pressure loss between filling attempts. This pressure loss has a direct correlation to the amount of additional fuel that can be added to the fuel tank on subsequent filling attempts. It allows an operator to potentially fill the fuel tank over its maximum rated capacity and ultimately compromises the ability to vent the fuel tank after the refueling. This is dangerous as it can lead to over pressurization of the fuel tank. Having the recirculation line arranged according to the present invention allows the pressure to be retained inside the tank between subsequent refilling attempts, drastically minimizing the amount of additional fuel that can be added to the tank and, ultimately, dissuading the operator from trying to add additional fuel so to keep the fuel tank fill level within the design limits.

As previously mentioned, it is common practice to place a rollover valve at the entry of a recirculation line of a fuel tank, and to have a rollover valve float shut at the end of a refueling event, precisely to achieve the benefit of minimal over-filling of the tank but, again, this comes at the monetary cost of an additional rollover valve and also at the cost of a system deficiency in terms of being able to detect any leaks in the filler pipe. It is partially for this reason that the California Air Resources Board (CARB) allows a deficiency in leak detection system in which they are not able to detect leaks above a fuel level of 85%. By arranging the recirculation line according to the present invention, the system is able to detect leaks large or small all the way to the maximum capacity, thus improving the performance of the leak detection system.

An additional advantage to the recirculation line arranged according to the present invention is that between the time at which the refilling ends and the operator finally closes off the filler pipe with the fuel tank cap, there is no chance of fuel vapor escape out the recirculation line, which is good for the environment but also conserves the energy created during the fill (due to the turbulence of the fuel in the tank) to be able to more consistently ensure that the fuel tank cap is properly closed. In the prior art either the recirculation line is left open squandering the pressure, or left closed prohibiting the check of a leak in the filler pipe or recirculation line without the addition of a pressure sensor directly in that system.

According to a preferred embodiment, the motor vehicle fuel tank is sealable and at a pressure higher than atmospheric pressure. Preferably, the motor vehicle fuel tank is a fuel tank for a hybrid electric vehicle.

It is another object of the present invention to provide a fuel tank cap detection system for verifying that a fuel tank cap is present and properly closed after refueling of a motor vehicle fuel tank, the fuel tank cap detection system comprising:
the fuel tank assembly,
a fuel tank cap to tightly close off the filler pipe,
a fuel door to permit access to the fuel tank cap,
a pressure sensor to monitor the internal pressure of the motor vehicle fuel tank,
a fuel level sensor to determine the volume of fuel contained within the motor vehicle fuel tank,
a fuel door sensor to determine whether the fuel door is open or closed,
an electrically actuated system isolation valve (SIV) connected in series in the vent line and coupled between the fuel vapor canister and the second port of the vent line.

Preferably, the TIV and SIV are two separate valves. This arrangement allows closing the electrically actuated system isolation valve prior opening the electrically actuated tank isolation valve, by doing so no flow is sent from the tank to the atmosphere.

Preferably, the fuel tank cap is coupled to the filler pipe. Preferably, the pressure sensor is coupled to the fuel tank. Preferably, the fuel level sensor is coupled to the fuel tank. Preferably, the fuel door sensor is coupled to the fuel door.

The fuel tank cap detection system according to the invention allows advantageously the ability to check for the presence of a fuel tank cap by means of monitoring the pressure in the fuel tank after a filling event and a defined closing sequence of the valves. The primary advantage of the invention is that the fuel tank cap detection system has the ability to close the fuel tank assembly at the end of a refueling event and use a single pressure sensor to be able to measure the pressure in the fuel tank assembly and confirm leak tightness or not. As mentioned above, such a system eliminates the issue of having two separate hydraulic systems at the end of a refueling event. Furthermore, the described isolation valves arrangement allows maximizing the amount of vapor that is recirculated and condensed back into the liquid fuel, thus limiting the loading of the canister and the need to purge it, all without sacrificing any refueling performance. This is especially helpful for hybrid and plug-in hybrid vehicles with limited purge capability. If the canister is not fully purged by the subsequent refueling event, there is a high probability there will be fuel vapors released to the atmosphere.

It is another object of the present invention to provide a non-transitory computer-readable medium comprising instructions for verifying that a fuel tank cap is present and properly closed after refueling of a motor vehicle fuel tank, which, when executed by a processor, cause the processor to perform steps according to the fuel tank cap detection method according to the present invention.

Advantageously, the processor is part of an electronic control unit (ECU) of the motor vehicle so that the ECU runs the fuel tank cap detection method.

The non-transitory computer-readable medium according to the present invention allows for the fuel tank cap detection system to actuate the isolation valves in the proper sequence, read values from the pressure sensor and thus make and report decisions as to the leak tightness of the fuel system and specifically the fuel tank cap. It also allows a bi-stable behavior of the recirculation line allowing it to close in times where it is advantageously closed and open in times where it is advantageously opened.

It is another object of the present invention to provide a motor vehicle comprising the fuel tank cap detection system according to the present invention.

The motor vehicle according to the invention allows an operator to discern between a true leak in the fuel system that warrants a visit to the vehicle garage, and the mis-installation of a fuel tank cap, which merely warrants the operator to go and re-tighten the fuel tank cap. The result is a reduced stress on the vehicle operator and the automaker who typically is financially responsible for diagnosing and repairing such emissions related problems.

The fuel tank concerned by the present invention is a hollow body of varying shapes, which may be equipped with various internal and/or external accessories, and even accessories passing through the wall of the chamber. It is preferably made of plastic, more preferably of HDPE (high density polyethylene) and especially surface treated (fluorinated) or including a barrier layer (made of EVOH (ethylene vinyl alcohol copolymer) or polyamide (SELAR® for instance).

According to the invention, the fuel tank cap may be a conventional one (generally screwed on the filler head) or it may be an automatic one (including a flap able to pivot under the action of a refueling dispenser, e.g. a filling gun). Fuel systems including such an automatic shutter are generally called “capless” systems, and the present invention may help detecting a failure of said system.

The pressure sensor mentioned above may be a specific pressure sensor dedicated to the fuel tank cap detection method. However, preferably, it is a pressure sensor already mounted on the fuel tank for transmitting pressure data to another part of the fuel system, like an OBD system for instance.

The fuel door sensor mentioned above is able to sense that the fuel door is open or closed. Any type of door sensor may be used provided it is able to send a signal to the ECU running the fuel tank cap detection method. Possible sensors are momentary contact less switches and Hall Effect switches.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1a-1d are flow diagrams of a fuel tank cap detection method according to the invention;

FIG. 2 is a diagrammatic view of a fuel tank cap detection system according to an embodiment of the present invention;

FIG. 3 is a view similar to FIG. 2 showing a prior art recirculation line;

FIG. 4 is a view similar to FIG. 2 of another embodiment of the present invention.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

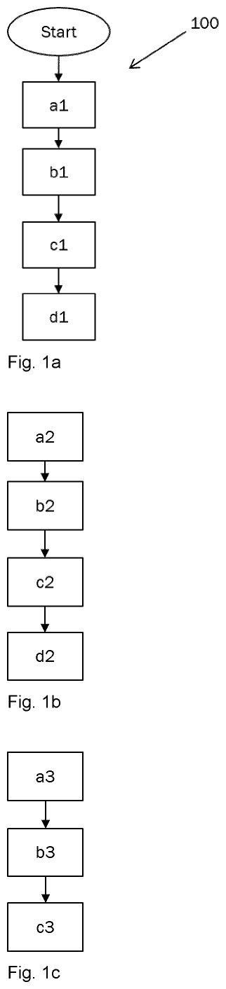

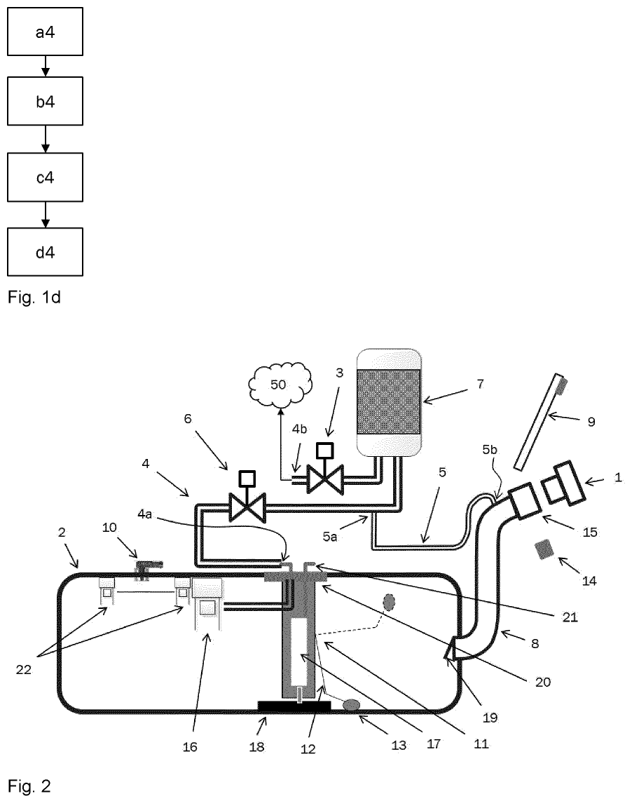

FIG. 1a to 1d show an example method 100 for verifying that a fuel tank cap is present and properly closed after refueling of a motor vehicle fuel tank in various conditions in accordance with the present disclosure. At step Start, method 100 starts. At step a1, in response to a request for refueling, method 100 enables refueling of a motor vehicle fuel tank 2 by opening a first vent valve 3 connected in series in a vent line 4, downstream from a first port 5a of a recirculation line 5 coupled to the vent line 4, so that to vent the motor vehicle fuel tank 2 to the atmosphere 50 through a fuel vapor canister 7. At step b1, method 100 disables refueling of the motor vehicle fuel tank 2 by closing the first vent valve 3. At step c1, method 100 monitors the internal pressure within the motor vehicle fuel tank 2 when the refueling request is finished. At step d1, method 100 concludes that the fuel tank cap 1 is deemed present and properly closed when the internal pressure increases and/or remains higher than the atmospheric pressure. Method 100 may then end.

Method 100 proceeds to step b1 when the refueling request is finished or, alternatively, when the fuel volume has reached a target fuel volume.

When the fuel volume has reached a target fuel volume, method 100 may proceed to step a2. At step a2, method 100 enables refueling of the motor vehicle fuel tank 2 by sequentially opening and closing the first vent valve 3. At step b2, method 100 increments a counter value by one. At step c2, method 100 determines whether the counter value has reached a threshold value, if the counter value has reached the threshold value, then the method proceeds to step c1; otherwise, the method proceeds to step d2. At step d2, method 100 determines whether additional fuel has been introduced into the motor vehicle fuel tank 2, if additional fuel has been introduced into the motor vehicle fuel tank 2, then the method returns to step a2; otherwise, the method proceeds to step c1.

At step a1, method 100 may open a second vent valve 6 connected in series in the vent line 4, upstream from the first port 5a of the recirculation line 5 coupled to the vent line 4, for enabling refueling of the motor vehicle fuel tank 2.

After step a1, method 100 may proceed to step a3. At step a3, method 100 determines whether the volume of fuel contained within the motor vehicle fuel tank 2 has reached a target fuel volume. At step b3, method 100 disables refueling of the motor vehicle fuel tank 2 by closing the second vent valve 6 when the fuel volume has reached the target fuel volume. At step c3, method 100 opens the second vent valve 6 and proceeding to step b1.

Method 100 proceeds to step c3 when the refueling request is finished.

After step b3, method 100 may proceed to step a4. At step a4, method 100 enables refueling of the motor vehicle fuel tank 2 by sequentially opening and closing the second vent valve 6. At step b4, method 100 increments a counter value by one. At step c4, method 100 determines whether the counter value has reached a threshold value, if the counter value has reached the threshold value, then the method proceeds to step c3; otherwise the method proceeds to step d4. At step d4, method 100 determines whether additional fuel has been introduced into the motor vehicle fuel tank 2, if additional fuel has been introduced into the motor vehicle fuel tank, then the method returns to step a4, otherwise, the method proceeds to step c3.

Method 100 may use an electrically actuated system isolation valve as first vent valve 3 and an electrically actuated tank isolation valve as second vent valve 6.

Method 100 may be carried out by an ECU and may be stored at the ECU as executable instructions in non-transitory memory. Instructions for carrying out method 100 and the test routines of the method included herein may be executed by the ECU based on instructions stored on the memory of the ECU and in conjunction with signals received from sensors and actuators of the system.

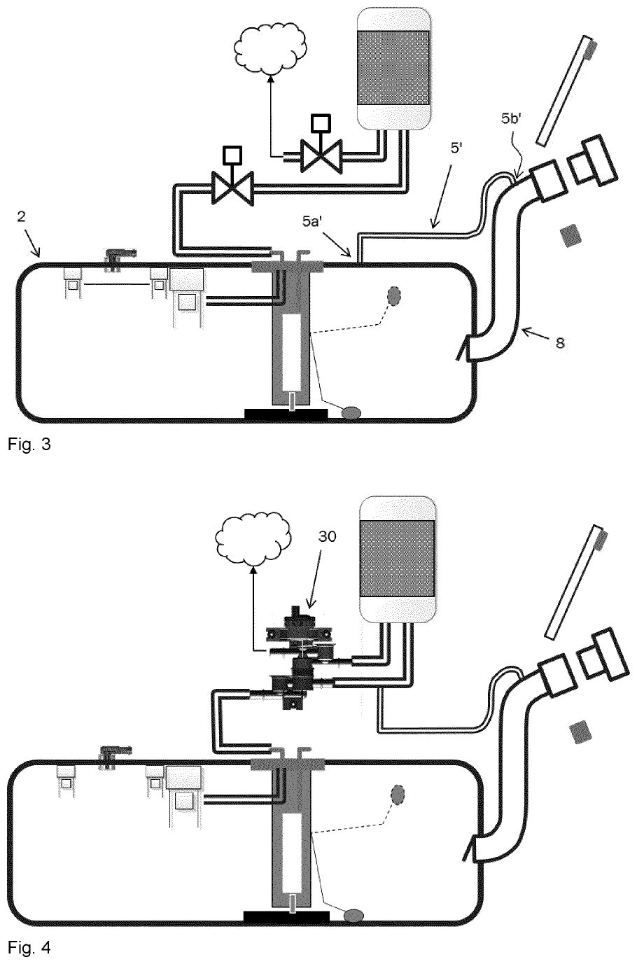

FIG. 2 is a diagrammatic view of a fuel tank cap detection system according to an embodiment of the invention. In this embodiment, the fuel tank cap detection system comprises a recirculation line 5 for a fuel tank assembly for a motor vehicle. The recirculation line 5 comprises a first port 5a at one end and a second port 5b at the other end. The first port 5a of the recirculation line 5 is coupled to a vent line 4 of a fuel tank assembly between an electrically actuated tank isolation valve 6 and a fuel vapor canister 7 and the second port 5b of the recirculation line 5 is coupled to a filler pipe 8 of the fuel tank assembly.

The recirculation line 5 is part of a fuel tank assembly for a motor vehicle comprising a motor vehicle fuel tank 2 fillable with fuel through the filler pipe 8. The vent line 4 has a first port 4a at one end and a second port 4b at the other end. The first port 4a of the vent line 4 is coupled to the motor vehicle fuel tank 2 and the second port 4b of the vent line 4 communicates with the atmosphere 50. The fuel vapor canister 7 is connected in series in the vent line 4 and coupled between the first 4a and second 4b ports of the vent line 4. The electrically actuated tank isolation valve 6 is connected in series in the vent line 4 and coupled between the motor vehicle fuel tank 2 and the fuel vapor canister 7.

In an example, the motor vehicle fuel tank 2 is sealable and at a pressure higher than atmospheric pressure.

The fuel tank assembly is part of the fuel tank cap detection system which further comprises a fuel tank cap 1 to tightly close off the filler pipe, a fuel door 9 to permit access to the fuel tank cap 1, a pressure sensor 10 to monitor the internal pressure of the motor vehicle fuel tank 2, a fuel level sensor 11 to determine the volume of fuel contained within the motor vehicle fuel tank 2, a fuel door sensor 14 to determine whether the fuel door 9 is open or closed, an electrically actuated system isolation valve 3 connected in series in the vent line 4 and coupled between the fuel vapor canister 7 and the second port 4b of the vent line 4.

The fuel level sensor 11 comprises a pivotable arm 12 having a float 13 attached at a free end of the pivotable arm 12. The filler pipe 8 comprises an upper part for receiving fuel from a refueling dispenser and a lower part for discharging the received fuel in the fuel tank 2. A filler head 15 is coupled to the upper part of the filler pipe 8 and an inlet check valve 19 is coupled to the lower part of the filler pipe 8. The fuel tank cap 1 is screwed on the filler head 15. The fuel tank assembly further comprises a fuel pump 17 associated with a fuel suction point 18, roll-over-valves 22 and a refueling control valve 16. The fuel pump 17 and the pump level sensor 11 are part of a fuel delivery module comprising a flange 20 and a fuel outlet 21 connecting the fuel pump 17 to a fuel feed line for the internal combustion engine (not shown).

The fuel tank cap detection system assembly is part of a motor vehicle (not shown).

FIG. 3 is a view similar to FIG. 2 showing a prior art recirculation line. The recirculation line 5′ of the prior art comprises a first port 5a′ at one end and a second port 5b′ at the other end. The first port 5a′ of the recirculation line 5′ is coupled to an opening located on the top of the fuel tank 2 and the second port 5b′ of the recirculation line 5′ is coupled to the filler pipe 8 of the fuel tank assembly. The drawback of this arrangement is that the internal pressure within the fuel tank cannot be maintained by closing the electrically actuated tank isolation valve 6 when the filler pipe is not closed.

FIG. 4 is a view similar to FIG. 2 of another embodiment of the present invention. In this alternative embodiment, the electrically actuated system isolation valve 3 and the electrically actuated tank isolation valve 6 are combined in one single valve device 30. The valve device 30 is set to simultaneously close the electrically actuated system isolation valve and open the electrically actuated tank isolation valve.

### LIST OF REFERENCES

1: fuel tank cap
2: motor vehicle fuel tank
3: first vent valve, electrically actuated system isolation valve
4: vent line
4a: first port of the vent line
4b: second port of the vent line
5: recirculation line
5a: first port of the recirculation line 5
5b: second port of the recirculation line 5
5′: recirculation line
5a′: first port of the recirculation line 5′
5b′: second port of the recirculation line 5′
6: second vent valve, electrically actuated tank isolation valve
7: fuel vapor canister
8: filler pipe
9: fuel door
10: pressure sensor
11: fuel level sensor
12: pivotable arm
13: float
14: fuel door sensor
15: filler head
16: refueling control valve
17: fuel pump
18: fuel suction point
19: inlet check valve
20: flange of the fuel delivery module
21: fuel outlet of the fuel delivery module
22: roll-over-valve
30: valve device
50: atmosphere
100: fuel tank cap detection method

1. A method for verifying that a fuel tank cap is present and properly closed after refueling of a motor vehicle fuel tank, the method comprising, in response to a request for refueling:
(a1) enabling refueling of the motor vehicle fuel tank by opening a first vent valve connected in series in a vent line, downstream from a first port of a recirculation line coupled to the vent line, so that to vent the motor vehicle fuel tank to the atmosphere through a fuel vapor canister,
(b1) disabling refueling of the motor vehicle fuel tank by closing the first vent valve,
(c1) monitoring the internal pressure within the motor vehicle fuel tank when the refueling request is finished; and
(d1) concluding that the fuel tank cap is deemed present and properly closed when the internal pressure increases and/or remains higher than the atmospheric pressure.

2. The method of claim 1, which proceeds to the disabling (b1) when the refueling request is finished.

3. The method of claim 1, which proceeds to the disabling (b1) when fuel volume has reached a target fuel volume.

4. The method of claim 3, further comprising, after the disabling (b1):
(a2) enabling refueling of the motor vehicle fuel tank by sequentially opening and closing the first vent valve;
(b2) incrementing a counter value by one;
(c2) determining whether the counter value has reached a threshold value, if the counter value has reached the threshold value, then proceeding to the monitoring (c1); otherwise, proceeding to the concluding (d2); and
(d2) determining whether additional fuel has been introduced into the motor vehicle fuel tank, if additional fuel has been introduced into the motor vehicle fuel tank, then returning to the enabling (a2); otherwise, proceeding to the monitoring (c1).

5. The method of claim 1, further comprising at the enabling (a1):
opening a second vent valve connected in series in the vent line, upstream from the first port of the recirculation line coupled to the vent line.

6. The method of claim 5, further comprising, after the enabling (a1):
(a3) determining whether the volume of fuel contained within the motor vehicle fuel tank has reached a target fuel volume;
(b3) disabling refueling of the motor vehicle fuel tank by closing the second vent valve when the fuel volume has reached the target fuel volume;
(c3) opening the second vent valve and proceeding to the disabling (b1).

7. The method of claim 6, which proceeds to the opening (c3) when the refueling request is finished.

8. The method of claim 6, further comprising, after the disabling (b3):
(a4) enabling refueling of the motor vehicle fuel tank by sequentially opening and closing the second vent valve;
(b4) incrementing a counter value by one;
(c4) determining whether the counter value has reached a threshold value, if the counter value has reached the threshold value, then proceeding to the opening (c3), otherwise proceeding to (d4); and
(d4) determining whether additional fuel has been introduced into the motor vehicle fuel tank, if additional fuel has been introduced into the motor vehicle fuel tank, then returning to the enabling (a4), otherwise, proceeding to the opening (c3).

9. The method of claim 5, wherein the second vent valve is an electrically actuated tank isolation valve.

10. The method of claim 1, wherein the first vent valve is an electrically actuated system isolation valve.

11. A recirculation line for a fuel tank assembly for a motor vehicle, comprising:
a first port at one end and a second port at the other end,
wherein the first port of the recirculation line is configured to be coupled to a vent line of a fuel tank assembly between an electrically actuated tank isolation valve and a fuel vapor canister, and
wherein the second port of the recirculation line is configured to be coupled to a filler pipe of the fuel tank assembly.

12. A fuel tank assembly suitable for a motor vehicle, the fuel tank assembly comprising:
the recirculation line of claim 11,
a motor vehicle fuel tank fillable with fuel through a filler pipe;
a vent line having a first port at one end and a second port at the other end, the first port of the vent line being coupled to the motor vehicle fuel tank and the second port of the vent line communicating with the atmosphere;
a fuel vapor canister connected in series in the vent line and coupled between the first and second ports of the vent line;
an electrically actuated tank isolation valve connected in series in the vent line and coupled between the motor vehicle fuel tank and the fuel vapor canister (7),
wherein the first port of the recirculation line is coupled to the vent line between the electrically actuated tank isolation valve and the fuel vapor canister and the second port of the recirculation line is coupled to the filler pipe.

13. The fuel tank assembly of claim 12, wherein the motor vehicle fuel tank is sealable and at a pressure higher than atmospheric pressure.

14. A fuel tank cap detection system suitable for verifying that a fuel tank cap is present and properly closed after refueling of a motor vehicle fuel tank, the fuel tank cap detection system comprising:
the fuel tank assembly of claim 12;
a fuel tank cap to tightly close off the filler pipe;
a fuel door to permit access to the fuel tank cap,
a pressure sensor to monitor the internal pressure of the motor vehicle fuel tank;
a fuel level sensor to determine the volume of fuel contained within the motor vehicle fuel tank;
a fuel door sensor to determine whether the fuel door is open or closed;
an electrically actuated system isolation valve connected in series in the vent line and coupled between the fuel vapor canister and the second port of the vent line.

15. A non-transitory computer-readable medium comprising instructions for verifying that a fuel tank cap is present and properly closed after refueling of a motor vehicle fuel tank, which, when executed by a processor, cause the processor to perform the method of claim 1.

16. A motor vehicle, comprising:
the fuel tank cap detection system of claim 14.
